(19) United States
(12) Patent Application Publication
(10) Pub. No.: US 2012/0037110 A1
(43) Pub. Date: Feb. 16, 2012

(54) SPIN BALANCED CRANK ASSEMBLY

(76) Inventor: Joseph M. Perkins, Tremonton, UT (US)

(21) Appl. No.: 13/280,249

(22) Filed: Oct. 24, 2011

Related U.S. Application Data
(60) Provisional application No. 61/406,894, filed on Oct. 26, 2010.

(51) Int. Cl. F16F 15/26; B23P 11/00

(52) U.S. Cl. 123/192.2; 29/888.01

(57) ABSTRACT

A spin balanced crank assembly for two-stroke and four-stroke engines, such as those used in snowmobiles and ATVs, is provided. The crank assembly may achieve an overall two-plane balance engine by adding two additional masses to opposing sides of the crank assembly. The additional masses are each unbalanced to a desired amount and angle in order to offset unbalance in the engine and obtain a balanced assembly. The amount of weight to be added or subtracted may be attached to the masses may be determined by the size and engine from which the crank assembly is a part of because the angle of unbalance of the crank assembly is know beforehand. Additionally, methods for spin balancing two-stroke and four-stroke engines are provided, wherein the method comprises balancing the engine without disassembling the crank.

### PRIORITY

The present application claims the benefit of U.S. Provisional Patent Application Ser. No. 61/406,894, filed Oct. 26, 2010, which is incorporated herein by reference in its entirety.

### THE FIELD OF THE INVENTION

The present invention relates to a spin balanced crank and clutch assembly and methods of producing the same. More specifically, the present invention relates to a spin balanced clutch, rotor and crank assembly that is particularly applicable for use in the two-stroke and four-stroke engines used in snowmobiles and all-terrain vehicles (ATVs), and methods of spin balancing said assembly.

### BACKGROUND

Reciprocating piston engines have a crankshaft that rotates at high speed and pistons and connecting rods that oscillate up and down with every revolution of the crank, all of which generates forces inside the engine. These parts are referred to as the engine's rotating assembly. Ideally, the sum of these centrifugal and translational forces equals zero. If they do not, the rotating assembly will generate friction and vibration, which wastes energy and will shorten the operating life of certain engine parts, e.g. bearings.

When the sum of the centrifugal and translational forces of the rotating assembly of an engine do not equal zero, the engine may be referred to as unbalanced. Unbalance may occur when the center-of-gravity of a rotating object is not aligned with its center-of-rotation. This unbalance misaligns the center of gravity and bearing journals of the engine rotating assembly, causing vibration and wear. In general, unbalance can occur at any lateral (axial) position along the rotating assembly and with any magnitude. This unbalance is a combination of static unbalance and couple unbalance and is called dynamic unbalance. The couple unbalance component only appears when the object is rotated; so measuring dynamic unbalance requires rotating the object. Dynamic unbalance must be corrected at two locations in the axial direction (e.g., two-plane correction for two-plane unbalance). Dynamic balancing machines measure the amount and angle of this unbalance.

Balance is of great concern with each rotating part on an engine. The magnitude of the force generated by unbalance in any given rotating part depends on two things: the revolutions per minute (rpm) of the unbalanced rotating engine part and the amount of unbalance. The larger and heavier the object and the faster it rotates, the greater the forces generated by any unbalance that exist. For a rotating crankshaft, the force at the main bearings is proportional to the speed of the engine squared. Also, the further the weight creating the unbalance is located from the center of gravity, the greater its effect on the rotating part as it spins.

Typically, with crankshafts, large heavy counterweights are used to offset the forces generated by the reciprocating weight of the pistons and rods. The crank must not only maintain its own balance as it rotates inside the block, it must also offset the forces generated by the mass of the pistons and rods as they pump up and down.

One problem with balancing two-stroke and four-stroke engines, such as those used in snowmobiles and ATVs, is that they typically comprise multiple separate pieces pressed together, making it extremely difficult, if not impossible, to put it on a hard bearing balancer without substantial support to hold the rods and pistons in place. Additionally, because they are in multiple pieces, the crank assemblies generally must have interior bearings along with the rods placed on the crank journals before they are pressed together. Thus, when using traditional methods to balance two-stroke and four-stroke engines, such as those used in snowmobiles and ATVs, the crank assembly has to be disassembled or pressed apart and the rods have to be removed in order to balance the engine.

Typically, when using traditional methods of balancing a crankshaft, the actual rods and pistons are not used in the balancing machine so they must be simulated. The simulated weight is called the bob-weight. Once the bob-weight is calculated from the weights of the reciprocating parts (e.g., the piston, ring set, wrist pin and small end of the rod), bob-weights are bolted onto the rod journals to simulate the weight of the reciprocating parts.

Once bob-weights are attached to the crank, the crank assembly is ready for spin balancing. The crank assembly is placed on a hard bearing balance machine and spun at the desired revolutions per minute. When the hard bearing balance is calibrated for a two-plane unbalance reading, which will give the angle and an amount of unbalance, the balance operator will be able to determine the amount of weight that should be added or subtracted and where that weight difference should occur in order to correct any unbalance present and achieve a completely balanced crank assembly on both ends of the motor. One downside of traditional methods of balancing two-stroke or four-stroke engines such as those used in snowmobiles and ATVs, however, is that it is both time and labor intensive and can take up to 25 hours or more to complete, which makes balancing these engines very costly to the consumer.

The alternative for the consumer, however, is to use the snowmobile or ATV without correcting the unbalance in its engine. There are several disadvantages of not correcting an unbalanced engine such as a snowmobile or ATV engine. These disadvantages include engine movement even when high density rubber motor mounts are used. The engine of a snowmobile can move between 0.05 and 0.125 inches when idling. Also, engine vibration may be transmitted to the handlebars and other parts of the snowmobile or ATV causing the rider to become fatigued. Although handlebar vibration dampeners may be mounted to the snowmobile or ATV to reduce the effects of an unbalanced engine, the vibrations still unnecessarily increase the wear on the snowmobile's or ATV's mechanical parts. For example, vibration can cause crank bearing failure, which may cause excessive crank run out, which in turn may result in the pistons seizing.

Another disadvantage of not correcting unbalance in two-stroke and four-stroke engines such as those used in a snowmobile or ATV is that vibration caused by the unbalanced engine may result in excessive heat build-up that may transfer to other parts or materials in contact with the engine. For example, excessive heat may cause the clutch belt to weaken and break, leading to failure of the clutch bushing, thus destroying the clutch.

Moreover, vibration caused by an unbalanced engine may fatigue the entire crank assembly, which can cause cylinders to crack, pistons to break off at the rod connection, and even cause clutches to break off at the power take off (PTO) end of the engine.

Several attempts have been made to address the problems with vibration in engines such as those used in snowmobiles and/or ATVs. Aftermarket manufacturers have designed heavy-duty load bearings for the PTO side of the crankshaft. However, this still requires disassembling the engine, removing the original bearing, and replacing it with the aftermarket bearing. This process may still be time consuming and expensive for the consumer; and, although this may increase the life of the crank assembly, it does not decrease the unbalance of the engine and vibrations associated therewith.

Aftermarket manufacturers have also designed a bearing that can be mounted to both the chassis and the crankshaft (e.g., the bearing is mounted on the outside of the motor). This bearing is mounted to the motor externally in addition to the crank assembly's original bearings. Again, this additional bearing may increase the life of the crank assembly, but it does not correct unbalance in an engine.

Additionally, some snowmobile manufacturers have designed certain snowmobiles to have engines mounted unconventionally at less than perpendicular (e.g., closer to parallel) to the long axis of the snowmobile, and provided snowmobiles with more robust rubber engine mounts to try and eliminate vibrations. However, these methods of reducing vibration in a snowmobile or ATV due to an unbalanced engine have had minimal success.

Thus, there is a need for an improved system and method for balancing the two-stroke or four-stroke engines used in snowmobiles and ATVs. Such a balancing system should be cost effective and easy to install.

### SUMMARY OF THE INVENTION

It is an object of the present invention to provide an improved system and method for correcting the unbalance in ATV and snowmobile engines.

According to one aspect of the present invention, at least one mass is added to the crankshaft assembly without opening the engine to thereby correct unbalance in the engine.

According to another aspect of the present invention, a first mass is added to the PTO side of an engine and a second mass is attached to the magneto side of an engine without opening the engine case assembly to thereby achieve a two-plane balance of the crank assembly.

According to another aspect of the present invention, a two-plane spin balanced crank assembly may be provided without adding weight to or subtracting weight from the crankshaft.

According to yet another aspect of the present invention, a two-plane spin balanced crank assembly may be achieved by attaching an unbalanced first mass to the PTO side of the crank assembly and by attaching an unbalanced second mass to the magneto side of the crank assembly.

According to still another aspect of the present invention, the mass attached to the PTO side of the crank assembly may be the primary clutch.

According to another aspect of the present invention, the amount and angle of unbalance of the primary clutch may be determined using a spin balancer, or other device for determining the angle of unbalance.

In accordance with another aspect of the present invention, the mass attached to the magneto side of the crank assembly may be a disk, rotor, flywheel, etc.

In accordance with still another aspect of the present invention, a balancing kit may be provided that may include the primary clutch (e.g., from a consumer's snowmobile or ATV), a disk, rotor, etc., a travel dial indicator (e.g., a travel dial indicator of about one inch), and an instructional video or instruction documentation.

According to another aspect of the present invention, a balance machine or vibration analysis machine may be attached to a motor and used to spin the crank/clutch/rotor assembly while the crank assembly remains in the motor case to balance the engine rotating assembly with the clutch and rotor.

According to still another aspect of the present invention, a consumer that orders the balancing kit may send their primary clutch to a balance operator, who places the clutch on a soft or hard bearing balance machine. The balance operator obtains an unbalance angle or balance. Then, material is either added to the primary clutch, or removed from the primary clutch, or both in order to compensate for the unbalance in the crank. The balance operator may then place a mark on the clutch to indicate how the clutch should be aligned relative to the crank assembly when it is re-installed. A corresponding alignment mark may be placed on the crank. The amount of unbalance may differ in an amount that is determined by the make and size of a motor and its associated crank assembly. In other words, if the size and make of the motor are known, then the unbalance that should be added or subtracted to the primary clutch can be determined.

According to another aspect of the present invention, a predetermined amount of unbalance may be calculated and added to or removed from a mass, such as a disk, rotor, etc., which in turn may be attached to a crank assembly. Again, the crank assembly may have an alignment mark placed thereon. The amount of unbalance may change according to the crank assembly associated with a given size and make of motor. If the size and make of the motor are known, then the unbalance that should be added or subtracted to the additional mass or rotor can be determined. The balance operator then places a mark on the additional mass or rotor to facilitate installation of the mass on the crank assembly.

In accordance with still another aspect of the present invention, high density pins may be used to add weight, or a milling machine may be used to remove weight in order to achieve a desired amount of unbalance.

These and other aspects of the present invention are realized in a spin balanced crank assembly and a method of producing the same as shown and described in the following figures and related description.

### BRIEF DESCRIPTION OF THE DRAWINGS

Various embodiments of the present invention are shown and described in reference to the numbered drawings wherein:

FIG. 1 shows a side view of a crank assembly in accordance with the prior art;

FIG. 2A shows a side view of a clutch as an example of a mass that may attach to one side of the crank assembly and be used to achieve a balanced crank assembly according to principles of the present invention;

FIG. 2B shows a top view of a disk or rotor as an example of a mass that may attach to one side of the crank assembly and be used to achieve a balanced crank assembly according to principles of the present invention;

FIG. 3 shows a side view of a crank assembly with two external, unbalanced masses installed to achieve an overall balanced crank assembly according to principles of the present invention;

FIG. 4 shows a partially exploded top view of a crank assembly showing the demarcations on the two external, unbalanced masses that aid in installation of the additional masses;

FIG. 5A shows a top view of a clutch after the amount and angle of unbalance has been determined and material has been removed/added in order to achieve a overall balance crank assembly when the clutch is installed;

FIG. 5B shows a back view of the clutch in FIG. 5A;

FIG. 6 shows a front view of a disk or rotor ready to be installed on a crank assembly to balance one side of the crank assembly; and

FIG. 7 shows a crank assembly that has been removed from an engine in its fully assembled state and placed on a balance machine.

It will be appreciated that the drawings are illustrative and not limiting of the scope of the invention which is defined by the appended claims. The various elements of the invention accomplish various aspects and objects of the invention. It is appreciated that not every element of the invention can be clearly displayed in a single drawing, and as such not every drawing shows each element of the invention.

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims.

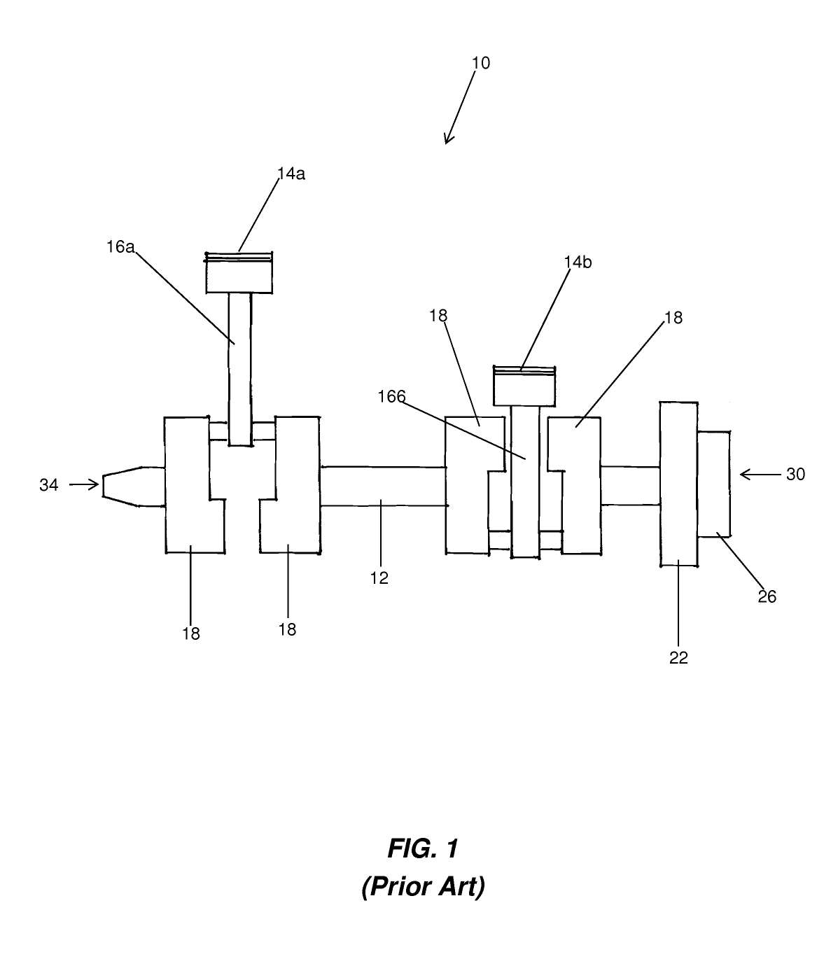

Turning to FIG. 1, there is shown a side view of a two-stroke or four-stroke crank assembly, generally indicated at 10, of a two cylinder motor according to principles of the prior art. The rotating assembly (including the crankshaft (often referred to simply as the crank), connecting rods and pistons) of a snowmobile motor is shown. The present invention is particularly suited to the engines of snowmobiles, ATVs and the like as these engines have multi-piece cranks which are pressed together with the connecting rods and pistons permanently installed on the crank. As compared to automobile engines, these rotating assemblies are more difficult to balance in a conventional manner as the rotating assembly is pressed together and the pistons and rods are not easily removed from the crank. The rotating assembly (crank assembly) 10 includes the crankshaft 12, pistons 14a and 14b and connecting rods 16a and 16b. Crank assembly 10 must be balanced along two-planes. The first plane may be located through the center of piston 14a. According to the present invention, this balance plane may be addressed through the PTO (power take off) or clutch side 34 of the crank 12. The second plane may be located through the center of piston 14b. According to the present invention, this balance plane may be addressed through the magneto or flywheel side 30 of crank 12.

In order to balance the crank assembly 10 using traditional engine balancing methods, counterweights 18 are added to the crank 12 opposite the connecting rod bearing journal to offset the weight of the pistons 14a, 14b and rods 16a, 16b. The pistons and rods are removed and bob weights are added to the crank to simulate the weight of the pistons and rods. The crank is then spin balanced on a balancing machine to determine if the counterweights are the correct size. If the counterweights are too heavy, material must be removed by drilling or milling the counterweights. If the counterweights are too light, weight must be added to the counterweights. This is usually done by drilling a hole in the counterweight and filling the hole with “heavy metal” or “mallory”. This filler metal is denser and heavier than steel so the weight of the counterweight will increase as a result. This is difficult to do with snowmobile engines or the like as the crank 12 is pressed together at the connecting rod bearing journals from multiple pieces, holding the connecting rods captive on the crank. Disassembly and reassembly of the crank 12 can weaken the pressed joint and may not result in perfect realignment of the assembled crank.

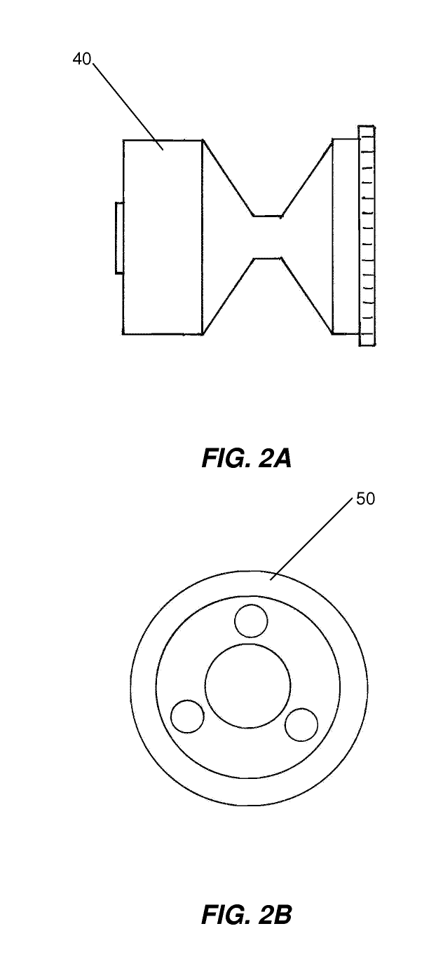

According to the present invention, the crank assembly 10 may be balanced exclusively through the use of external weights and without modification of the crank assembly itself. FIGS. 2A and 2B show two examples of masses, a clutch 40 and a rotor 50, respectively, that may attach to opposite sides of a crank assembly (see e.g. FIG. 1, reference numeral 10) in order to achieve a balanced crank assembly. Mass 40 may be the original primary clutch which attaches to the PTO side of a crank assembly and mass 50 may be an additional rotor that attaches to the opposite magneto side of a crank assembly. According to the present invention, these two masses are “balanced” to a predetermined degree of unbalance prior to installation on the crank assembly and, once installed, become part of the crank assembly creating a balanced motor or engine.

It should be appreciated that installing masses 40 and 50, which have been single-plane balanced or unbalanced, to the crank assembly in order to achieve a two-plane balanced motor or engine does not require removing or adding material to the original crank assembly. Thus a two-plane balanced engine or motor may achieved without opening the engine case assembly and, more importantly, without disassembly of the crank 12.

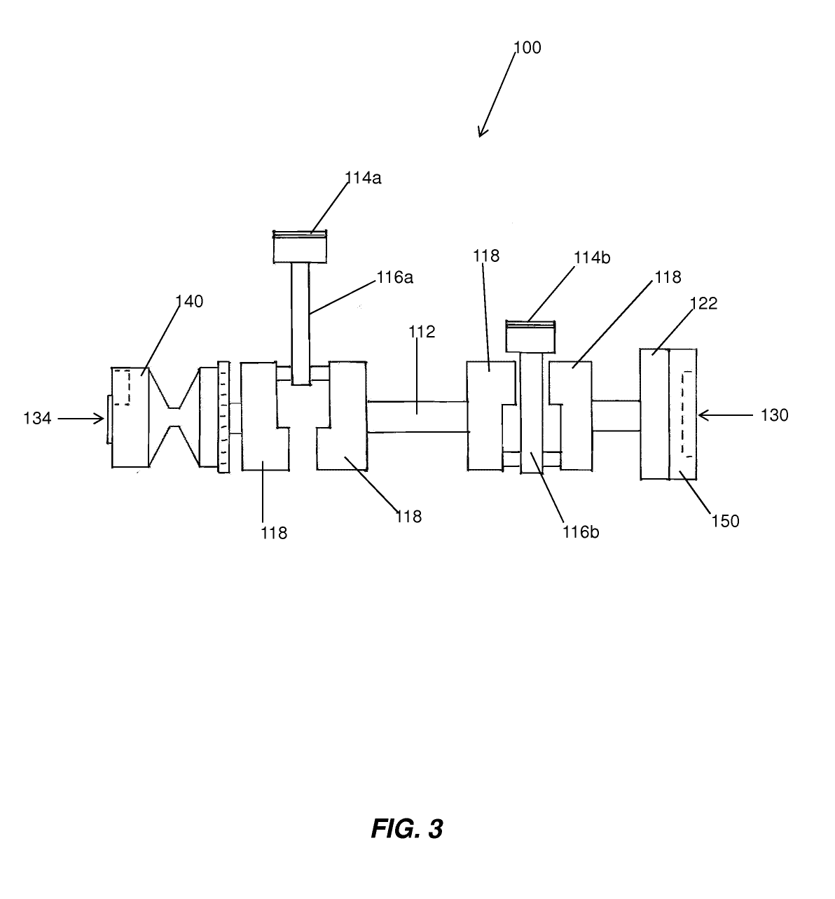

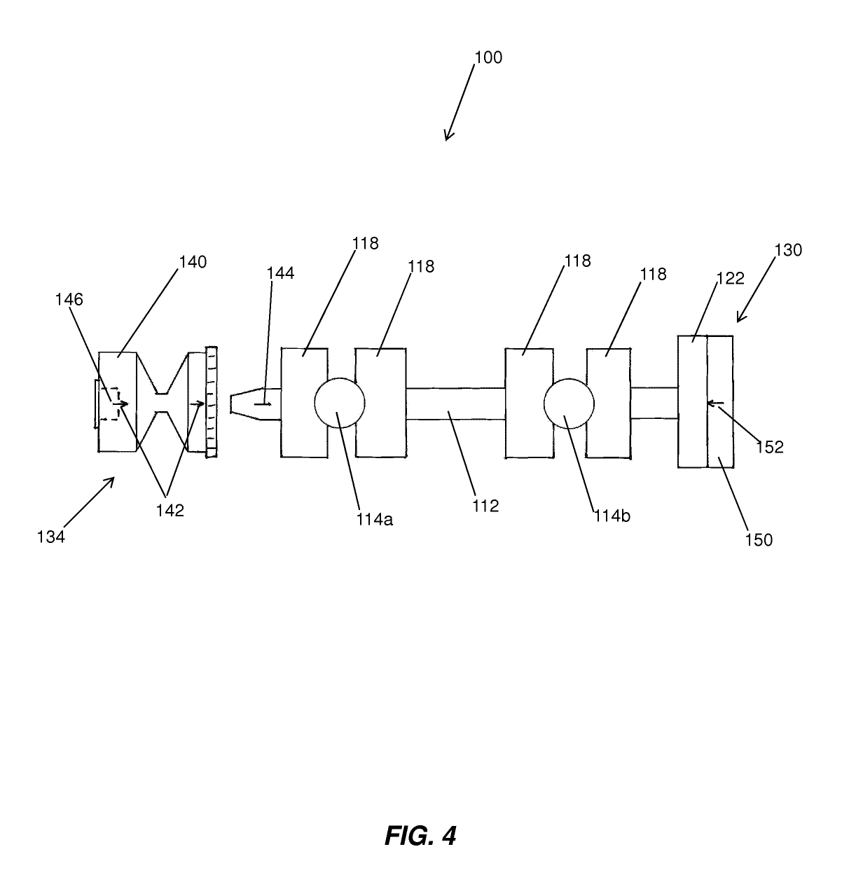

Now turning to FIGS. 3 and 4, which show a side and top view, respectively, of a crank assembly, generally indicated at 100, with two external, single-plane unbalanced masses installed to achieve a balanced crank assembly according to principles of the present invention. Reference numerals correspond to those used previously (with 100 added thereto) to indicate that the rotating assembly 100 has now been balanced through the use of weights external to the engine. Attached at the PTO side 134 of crank 120 may be the primary clutch 140. The primary clutch 140 is adjusted to a predetermined degree of unbalance in order to offset the unbalance of the crank assembly 100. Likewise, a mass or rotor 150 may be adjusted to a predetermined degree of unbalance and attached to the magneto side 130 of crank assembly 100.

Because the unbalance in a crank assembly associated with a given size and make of an engine may be determined and is typically similar for different engines of that size and make, the amount of unbalance that must be added to the two masses 140, 150 can be predetermined. Thus, a balance operator may separately single-plane balance each of the two masses 140, 150 and add or subtract a predetermined amount of weight at the appropriate angle to achieve the predetermined amount of unbalance. Once the balance operator has added the predetermined amount of weight to the two masses 140, 150, then the two masses can be installed as part of the overall crank assembly 100 to achieve a two-plane balanced engine.

According to another aspect of the present invention, a balancing kit may be provided to a consumer that comprises an unbalanced clutch (generally provided by consumer), an unbalanced disk or rotor, etc., a travel dial indicator (e.g., a travel dial indicator of about one inch), and an instructional video or documentation. A consumer that desires to have a balanced engine may order the balancing kit, in whole or in part, as an alternative to the traditional methods of balancing a crank assembly and attach the unbalanced clutch and rotor to the engine crank as discussed above. The consumer may send their primary clutch to a balance operator, who places the clutch on a soft or hard bearing balance machine. The balance operator obtains an unbalance angle for the clutch. Then, material is either added to the primary clutch, or removed from the primary clutch in order to achieve a desired angle and amount of unbalance. The amount of unbalance may change according to the crank assembly associated with a given size and make of motor. If the size and make of the motor are known, then the final amount of unbalance for the clutch can be determined. As can be seen in FIG. 4, the balance operator then places an indicator mark or marks 142, on the primary clutch 140 to aid the consumer in installing the primary clutch on the crank assembly.

Not every primary clutch 140 may have the same angle of unbalance, however the angle of unbalance in each crank assembly associated with a given engine of the same make and size may be about the same. Thus, once the angle of unbalance of the clutch 140 is determined by the balance operator, the correct position in which the clutch 140 should be mounted to the crank assembly 100 may be determined because it will be mounted to the crank in the same location for each motor of the same make and size. An instructional video/documentation can be included with the kit which instructs the consumer how and/or where to place a corresponding mark on the crank in order to facilitate installation of the clutch 140 thereto, as is described in more detail below.

Additionally, an external balancing mass 150, such as a disk, rotor, etc., may be included as part of the balancing kit. A predetermined amount of unbalance may be calculated to be added or subtracted to the mass 150 using high density pins to add weight or a milling machine to remove weight opposite the angle of unbalance. Similar to what was described above with respect to the amount of unbalance added or subtracted to the clutch 140, the amount of unbalance added or subtracted to the additional mass or rotor 150 may change according to the crank assembly associated with a given size and make of motor. If the size and make of the motor are known, then the final degree of unbalance of the mass 150 can be determined. The balance operator may then place a mark on the mass 150 to facilitate installation of the mass 150 on the crank assembly 100.

The balance kit assembly may also include a dial indicator such as a one inch dial indicator (alternatively, the consumer may purchase this separately) and an instructional video. The instructional video/documentation may instruct the consumer how to properly install the two masses 140, 150 on the crank assembly to achieve a two-plane balanced engine or motor.

For purposes of installing the two masses on a crank assembly 100 of a snowmobile or ATV engine, the instructional video/documentation may demonstrate the following: removing the spark wire from the clutch side of the motor; using a spark plug wrench to remove the spark plug; taking the dial indicator and placing the side with the rounded stem or shaft side in the opening left by removing the spark plug and letting it rest on the top of the piston 114a; resting the dial indicator on top the cylinder hole; rotating the crank to obtain the top of the stroke of piston 114a (the dial indicator will continue to move in an upward motion until you obtain the top of the stroke of the piston, once the piston starts down again the dial indicator will show this downward motion); and placing a mark on the top of the crank 144 and the face of the crank. To install the primary clutch 140, the mark 142 placed on the primary clutch by the balance operator should line up with the mark 144 placed on the top face of the crank when attached to the crank assembly 100.

Likewise, the mark 152 placed on the unbalanced mass 150 will be aligned with the mark 142 placed on clutch 140 (e.g., marks will generally line up towards the top of the stroke of the piston on the clutch side). On the magneto side of the crank assembly 100 (on the side where the rotor 150 is attached) the mark 152 is generally aligned to the bottom of the adjacent piston's (114b) stroke. Once the two masses 140, 150 are installed onto the crank assembly 100, the dial indicator can be removed and the spark plug and spark plug wire replaced.

The instructional video may provide instructional steps on how to achieve a two-plane balanced crank assembly, such as for use in two-stroke or four-stroke engines that are used in snowmobiles and ATVs. In addition to the instructional video, pictures may be provided that can be used for visual reference.

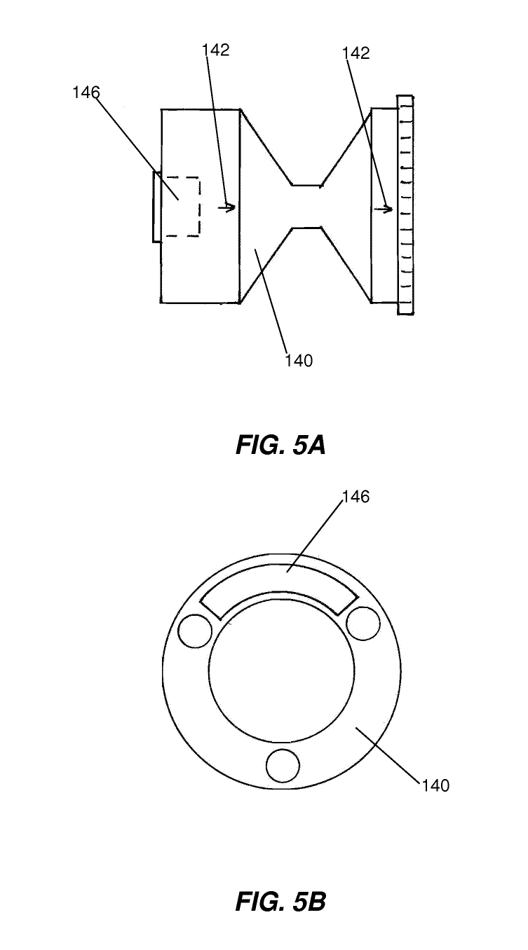

Now turning to FIGS. 5A and 5B, there is shown a primary clutch 140 after it has been adjusted to a specific degree of unbalance according to principles of the present invention. In order to balance the PTO side of crank assembly a weight 146 must be removed (or added) to clutch 140 at a specific angle and amount of unbalance. In order to prepare the clutch 140, a balance operator places the clutch 140 in a soft or hard balancing machine and adds or subtracts weight until the desired angle and mount of unbalance has been achieved. The balance operator may then place a mark 142 on the clutch 140 to facilitate re-installation of the clutch.

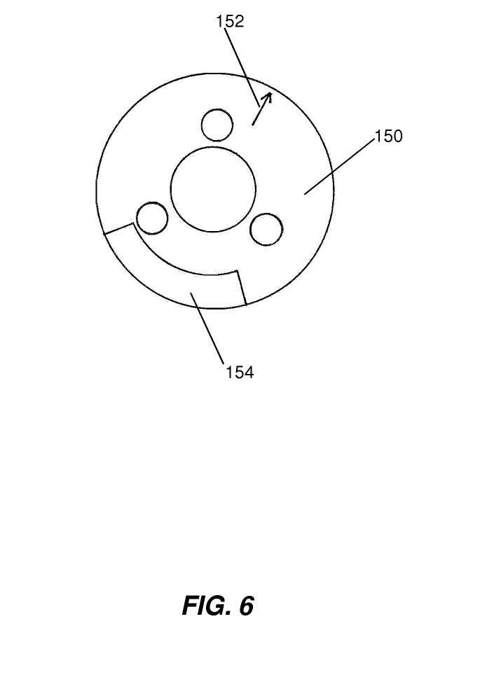

As can be seen in FIG. 6, an additional unbalanced mass 150, such as a rotor, may be provided to balance the magneto side of a crank assembly 100. Although an unbalanced clutch as discussed above addresses a significant amount of the rotating assembly unbalance, using an unbalanced rotor 150 in addition to the unbalanced clutch 140 improves the resulting balance of the engine. A balance operator removes or adds weight to the rotor 150 at a desired location to achieve a predetermined angle and degree of unbalance according to the engine to which the rotor will be mounted. As explained in further detail above, a weight 154 may be added or subtracted from the disk or rotor 150 depending on the make and size of the engine to which the rotor 150 will ultimately be attached. Also, the balance operator may make a mark 152 on the rotor 150 to facilitate its installation.

According to another aspect of the present invention, a two-stroke or four-stroke engine typically of the type used in snowmobiles and ATVs may be balanced without disassembling the crank assembly. Typically, the crank assemblies of two-stroke and four-stroke engines such as those used in snowmobiles and other ATVs comprise multiple separate pieces pressed together at the connecting rod journals to hold the connecting rods captive on the crank, making traditional balancing impractical.

The present invention includes several methods for balancing two-stroke and four-stroke engines without the need to disassemble and reassemble the crank. A snowmobile engine or similar engine of unknown unbalance may be balanced without the need to disassemble and reassemble the crank assembly. The rotating assembly (crank, pistons and rods) remains in the engine block. In order to balance the rotating assembly, a portable balance machine may be mounted to both sides of the engine block using the sensing pickups of the portable balancing machine. The clutch 140 and crankshaft are marked so as to index them to each other. The rotating assembly is then rotated to determine the amount of unbalance and the correction needed. As discussed above, material is added to or removed from the clutch 140 to thereby offset the unbalance of the rotating assembly. Additionally, a rotor 150 can be attached to the side of the crank 112 opposite the clutch 140 and material may be added to of removed the rotor 150 to thereby compensate for the unbalance of the engine crank without modifying the crank itself. In this manner, the engine can be balanced without even opening the engine crankcase.

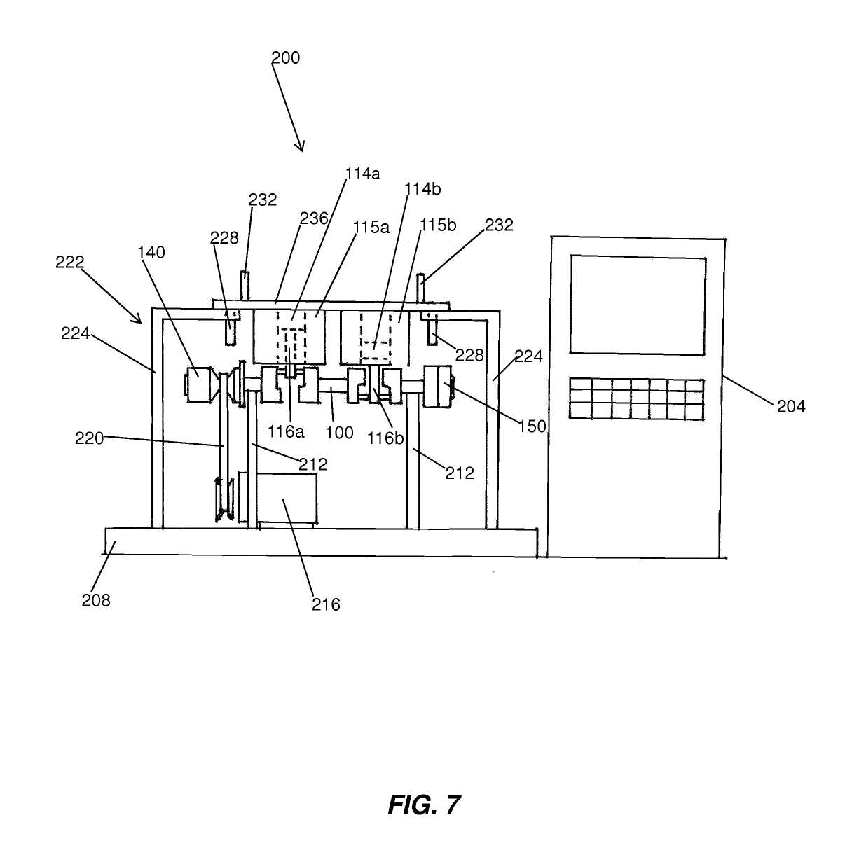

FIG. 7 shows a balancing method wherein the crank assembly 100 has been removed from an engine in its fully assembled state and placed on a balance machine, generally indicated at 200. The angle and amount of unbalance can then be determined using a soft or hard bearing balance. According to principles of the present invention, however, a hard bearing balance machine may be more preferable.

When a hard bearing balance is used to determine the angle and amount of unbalance in a two-stroke or four-stroke engine, the crank assembly 100 is placed on the hard bearing carriages 212. The hard bearing carriages include roller bearings which allow the crank assembly 100 to rotate. Rotation of the crank assembly 100 may be accomplished by operably connecting motor 216 to crank assembly 100 via belt 220.

The balance machine 200 may include tooling 222 to support the cylinders 115a, 115b of the engine on the balance machine 200. Alternatively, the tooling 222 may hold cylinder bores 115a, 115b which simulate the engine cylinder bores. In this manner, the tooling 222 supports the pistons 114a, 114b and rods 116a, 116b in positions that simulate the position the pistons and rods would be in, relative to the crankshaft, when the crank assembly 100 is located in the snowmobile or ATV's motor. More specifically, cylinders 115a, 115b may be attached to top plate 236 which, in turn, is placed on bottom supports 224. Top plate 236 may include handles 232 to facilitate placement of the cylinders 115a, 115b on the balance machine. Additionally, to facilitate placement of the top plate 236 and cylinders 115a, 115b on bottom supports 224, the balance machine 200 may include dowel pins 228. Once the crank assembly 100 is properly located on balance machine 200 the crank assembly can be rotated and the angle and amount of unbalance can be determined and the appropriate corrections can be made to the crank itself. Adjustments to the crank itself may be made in the conventional manner, drilling holes in the crank counterweights to lighten the same or drilling and installing heavy metal pins in the counterweights to make them more heavy.

The methods described above may also include adding an additional, separate mass (such as a disk or rotor 150) to the magneto side of the motor which can aid in achieve a more accurate and precise balancing of the motor.

The balancing described herein typically results in the balanced motor generating additional horse power because when the motor is balanced it is able to rotate more freely and less energy is lost to the vibrational motion created by the unbalance, which in turn may increase horse power, torque, and performance. Also, balancing a two-stroke or four-stroke engine using the methods described above may substantially increase the life of the crank assembly and bearings.

There is thus disclosed a spin balanced crank assembly and methods for producing the same. It will be appreciated that numerous changes may be made to the present invention without departing from the scope of the claims. The appended claims are intended to cover such modifications.

What is claimed is:

1. An engine assembly comprising:
a rotating assembly comprising a crankshaft, connecting rods and pistons which are not balanced;
a first mass attached to a first side of said crankshaft on the outside of the engine crankcase, the first mass being adjusted to a specific angle and amount of unbalance so as to offset the unbalance of the rotating assembly.

2. The assembly of claim 1, wherein the first mass is a clutch.

3. The assembly of claim 1, wherein the first mass is marked to index the first mass to the crankshaft.

4. The assembly of claim 1, further comprising a second mass attached to a second side of said crankshaft on the outside of the engine crankcase, the second mass being adjusted to a specific angle and amount of unbalance so as to offset the unbalance of the rotating assembly.

5. The assembly of claim 4, wherein the second mass is a circular rotor.

6. The assembly of claim 1, wherein the engine is a two cylinder engine.

7. The assembly of claim 1, wherein the engine is a snowmobile engine.

8. The assembly of claim 1, wherein the crankshaft comprises multiple pieces pressed together.

9. The assembly of claim 1, wherein the crankshaft does not have metal removed therefrom or added thereto.

10. A method of balancing an engine comprising:
selecting an engine having an unbalanced rotating assembly comprising a crankshaft, connecting rods and pistons;
determining the angle and amount of unbalance in the rotating assembly;
adjusting the weight of a first external mass such that the first external mass has an angle and amount of unbalance to offset the unbalance of the rotating assembly; and
attaching the first external mass to the engine crankshaft to balance the engine.

11. The method of claim 10, wherein the first external mass is a clutch.

12. The method of claim 10, wherein the method further comprises indexing the first external mass to the engine.

13. The method of claim 10, wherein the step of adjusting the weight of a first external mass more specifically comprises:
adjusting the weight of a first external mass such that the first external mass has an angle and amount of unbalance;
adjusting the weight of a second external mass such that the second external mass has an angle and amount of unbalance, the first and second external masses collectively having angles and amounts of unbalance to offset the unbalance of the rotating assembly; and
attaching the first and second external masses to opposing ends of the crankshaft to balance the engine.

14. The method of claim 13, wherein the first external mass is a clutch and the second external mass is a rotor.

15. The method of claim 10, wherein the engine is a two cylinder engine.

16. The method of claim 10, wherein the engine is a snowmobile engine.

17. The method of claim 10, wherein the engine has a multi-piece crankshaft which is pressed together.

18. The method of claim 10, wherein weight is not added to or removed from the crankshaft.

19. A method of balancing an engine rotating assembly comprising:
placing a rotating assembly comprising a crankshaft, connecting rods and pistons in a balancing machine;
placing the pistons in cylinder bores in the balancing machine to constrain the motion of the pistons to a reciprocating motion;
rotating the rotating assembly to determine the rotating assembly unbalance; and
adjusting the weight of the crankshaft to correct the rotating assembly unbalance.
